(19) United States
(12) Patent Application Publication
(10) Pub. No.: US 2021/0278040 A1
(43) Pub. Date: Sep. 9, 2021

(54) PROTECTIVE CASING STRUCTURE, HANDHELD GIMBAL, AND IMAGING DEVICE

(71) Applicant: SZ DJI TECHNOLOGY CO., LTD., Shenzhen (CN)

(72) Inventors: Xuan WU, Shenzhen (CN); Lei ZHANG, Shenzhen (CN); Dexi LI, Shenzhen (CN)

(21) Appl. No.: 17/326,323

(22) Filed: May 20, 2021

Related U.S. Application Data
(63) Continuation of application No. PCT/CN2018/118027, filed on Nov. 28, 2018.

(51) Int. Cl. F16M 13/04; G03B 17/56; F16M 13/02; H04N 5/225

(52) U.S. Cl. CPC F16M 13/04; G03B 17/561; F16M 11/12; H04N 5/2253; F16M 2200/00; F16M 13/022

(57) ABSTRACT

A protective casing structure includes a hood assembly including a hood, a casing used to be locked to the hood assembly to form a sealed cavity, and a mounting member arranged in the sealed cavity and used to mount an electronic device. One end of the casing is provided with an opening adapted to a shape of and abutting against the hood. The sealed cavity provides a space for the electronic device to move in the space.

### CROSS-REFERENCE TO RELATED APPLICATION

This application is a continuation of International Application No. PCT/CN2018/118027, filed Nov. 28, 2018, the entire content of which is incorporated herein by reference.

### TECHNICAL FIELD

The present disclosure relates to the field of electronic device protection and, in particular, to a protective casing structure, a handheld gimbal, and an imaging device.

### BACKGROUND

In the existing technology, some electronic devices need waterproof and dustproof protective structures when the electronic devices are used in special using scenarios. For example, when an action camera or single-lens reflex (SLR) camera is used in rain or underwater, a waterproof casing needs to be added to the camera. A shape of the existing protective casing is generally configured to fit a contour of the camera, a limited space is provided by the existing protective casing to accommodate the camera, and the camera with the existing protective casing is hard to be combined and used with a gimbal in these special using scenarios.

Therefore, how to combine the waterproof of the camera with the gimbal has become one of important factors that limit the use of the camera.

### SUMMARY

In accordance with the disclosure, there is provided a protective casing structure includes a hood assembly including a hood, a casing used to be locked to the hood assembly to form a sealed cavity, and a mounting member arranged in the sealed cavity and used to mount an electronic device. One end of the casing is provided with an opening adapted to a shape of and abutting against the hood. The sealed cavity provides a space for the electronic device to move in the space.

Also in accordance with the disclosure, there is provided a handheld gimbal including a protective casing structure and a gimbal fixed at a mounting member and used to mount an electronic device. The protective casing structure includes a hood assembly including a hood, a casing used to be locked to the hood assembly to form a sealed cavity, and the mounting member arranged in the sealed cavity. One end of the casing is provided with an opening adapted to a shape of and abutting against the hood. The sealed cavity provides a space for the electronic device to move in the space.

Also in accordance with the disclosure, there is provided an imaging device including a handheld gimbal and a camera mounted at a gimbal. The handheld gimbal includes a protective casing structure and the gimbal fixed at a mounting member. The protective casing structure includes a hood assembly including a hood, a casing used to be locked to the hood assembly to form a sealed cavity, and the mounting member arranged in the sealed cavity. One end of the casing is provided with an opening adapted to a shape of and abutting against the hood. The sealed cavity provides a space for the camera to move in the space.

### BRIEF DESCRIPTION OF THE DRAWINGS

FIG. 1 is a schematic diagram of a protective casing structure consistent with embodiments of the disclosure.

FIG. 2 is a schematic diagram of the protective casing structure without a hood assembly consistent with embodiments of the disclosure.

FIG. 3 is another schematic diagram of the protective casing structure consistent with embodiments of the disclosure.

FIG. 4 is an exploded view of the protective casing structure in FIG. 3.

FIG. 5 is a cross-sectional view of the protective casing structure in FIG. 3.

FIG. 6 is an enlarged schematic diagram of part A in FIG. 5.

FIG. 7 is a sectional exploded view of a support and a casing in FIG. 6.

FIG. 8 is a schematic exploded structural diagram of an example loading assembly consistent with the embodiments of the disclosure.

FIG. 9 is a schematic exploded structural diagram of an example key assembly consistent with the embodiments of the disclosure.

FIG. 10 is an enlarged schematic diagram of part B in FIG. 5.

FIG. 11 is a schematic diagram showing the protective casing structure without the hood assembly being applied with a gimbal and a camera.

Main reference numerals: Casing 10; Convex 10a; Concave 10b; Outer thread 101; First mounting member 102; Third mounting member 103; Through hole 104; Connector 105; First convex ring 11; Second convex ring 12; Snap 13; Hood assembly 20; Outer boss 201; First connector 202; Groove 203; Groove wall 203a, 203b; See-through member 21; Support 22; Fastener 30; Inner thread 31; Inner boss 32; Second connector 320; Loading assembly 40; First fixed loading member 41; First sliding groove 411; Concave point 412; Second fixed loading member 42; Movable loading member 43; First elastic edge 431; Second elastic edge 432; Convex point 433; Soft rubber structure 434; Third fixed loading member 44; Key assembly 50; Package 51; Pressing member 52; End cap 521; Limiting flange 5211; Pressing shaft 522; Resetting member 53; Sealing ring 54; Sealing cover 55; Sealing member 60; Gimbal 70; Camera 80.

### DETAILED DESCRIPTION OF THE EMBODIMENTS

Technical solutions of the present disclosure will be described with reference to the drawings. It will be appreciated that the described embodiments are some rather than all of the embodiments of the present disclosure. Other embodiments conceived by those having ordinary skills in the art on the basis of the described embodiments without inventive efforts should fall within the scope of the present disclosure.

Reference to “embodiments” herein refers that a specific feature, structure, or characteristic described in conjunction with the embodiments may be included in at least one embodiment of the present disclosure. The appearance of the phrase “embodiments” in various places in the specification does not necessarily refer to a same embodiment, nor an independent or alternative embodiment mutually exclusive with other embodiments. When there is no conflict, the embodiments described herein can be combined with other embodiments.

A protective casing structure consistent with the embodiments of the present disclosure used for loading an electronic device, includes a casing and a hood assembly. One end of the casing is provided with an opening adapted to a shape of a hood of the hood assembly. The opening and the hood abut against each other. The casing and the hood assembly can be locked to each other to form a sealed cavity. The sealed cavity is provided with a mounting member for mounting an electronic device, and the sealed cavity is provided with an activity space for the electronic device. While the protective casing structure protects the electronic device, the sealed cavity can also provide the activity space for a movable member of the electronic device. Therefore, when the electronic device is mounted with the protective casing structure, there is enough space in the sealed cavity for working of the electronic device cooperated with a gimbal.

Based on the above-described protective casing structure, a handheld gimbal consistent with the embodiments of the present disclosure includes a gimbal and the protective casing structure. An electronic device is loaded at the gimbal, and the gimbal is fixed mounted at the mounting member in the sealed cavity. The handheld gimbal can be used with the electronic device to enable the electronic device to be used stably in the sealed cavity of the protective casing structure.

Based on the above-described handheld gimbal, an imaging device consistent with the embodiments of the present disclosure includes a camera and the handheld gimbal. The camera is mounted at the gimbal. The camera can be adapted to imaging of special scenes under the protection of the protective casing structure and can achieve stable imaging by cooperating with the gimbal.

Some specific embodiments of the present disclosure will be described in detail below with reference to the drawings.

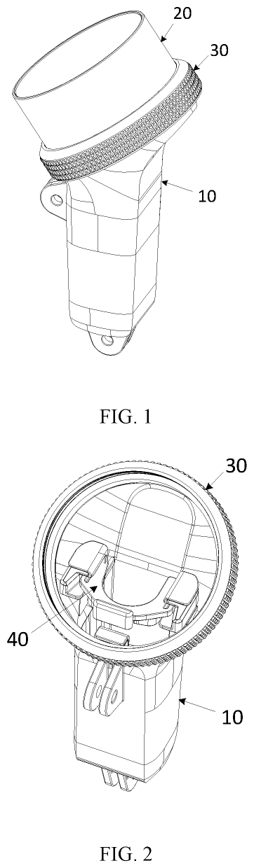

The protective casing structure consistent with the embodiments of the present disclosure is used for loading an electronic. In the following embodiments of the present disclosure, unless otherwise specified, the electronic device is specifically described by taking a camera and a gimbal as an example. FIG. 1 is a schematic diagram of a protective casing structure consistent with embodiments of the disclosure. As shown in FIG. 1, the protective casing structure includes a casing 10 and a hood assembly 20. One end of the casing 10 is provided with an opening adapted to a shape of a hood of the hood assembly 20. The opening and the hood abut against each other. The casing 10 and the hood assembly 20 can be locked with each other to form a sealed cavity. The sealed cavity is provided with a mounting member for mounting the electronic device, and the sealed cavity is provided with an activity space for the electronic device.

As shown in FIG. 1, the protective casing structure includes a fastener 30. The casing 10 and the hood assembly 20 are locked to each other by the fastener 30. In some embodiments, the fastener 30 may also be an integral structure with the casing 10 or the hood assembly 20. That is, the fastener 30 may be a fastening member included in one of the casing 10 and the hood assembly 20. The other one of the casing 10 and the hood assembly 20 is provided with a fastener fitting member that cooperates with the fastening member. The fastening member cooperates with the fastener fitting member to realize a fastening connection between the casing 10 and the hood assembly 20. For example, the fastening member and the fastening fitting member may correspond to a threaded structure or a buckle structure.

FIG. 2 is a schematic diagram of the protective casing structure without the hood assembly 20 consistent with embodiments of the disclosure. As shown in FIG. 2, the protective casing structure further includes a loading assembly 40 for mounting the electronic device. The loading assembly 40 is arranged in the sealed cavity. The loading assembly 40 includes at least one fixed loading member detachably connected with the mounting member. In some embodiment, the loading assembly 40 may be connected to the mounting member by a manner, for example, gluing, snapping, or screwing, to cause the gimbal and the camera as a whole to be stably mounted in the sealed cavity.

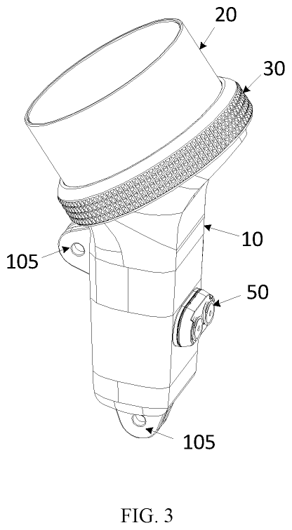

FIG. 3 is another schematic diagram of the protective casing structure consistent with embodiments of the disclosure. As shown in FIG. 3, the protective casing structure further includes a key assembly 50. The casing 10 may further provided with a key mounting member. The key assembly 50 may be mounted at the key mounting member.

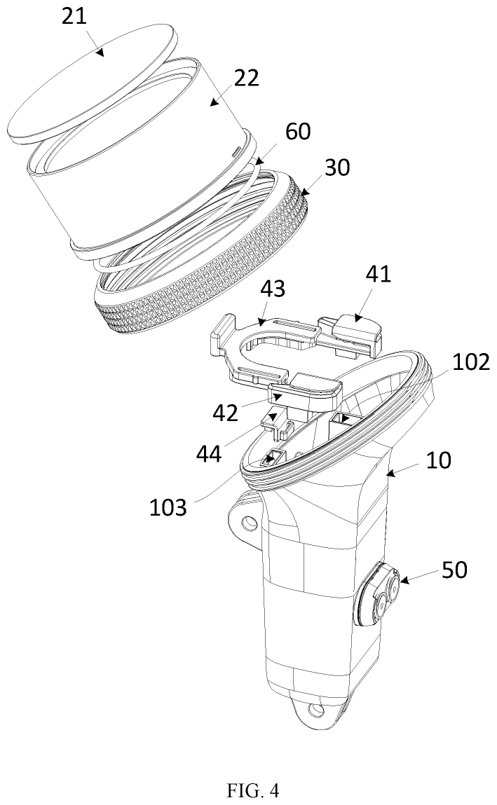

FIG. 4 is an exploded view of the protective casing structure in FIG. 3. As shown in FIG. 4, the protective casing structure further includes a sealing member 60 arranged at an abutment between the casing 10 and the hood assembly 20. After the casing 10 and the hood assembly 20 are locked to each other, the casing 10 and the hood assembly 20 compress the sealing member 60, thereby achieving an effect of sealing, waterproof, and dustproof.

As shown in FIG. 4, the hood assembly 20 includes a see-through member 21 and a support 22. The see-through member 21 may be provided with a see-through unit facing the electronic device loaded in the sealed cavity. The support 22 includes an inner cavity that penetrates the support 22. One end of the inner cavity is fixed with the see-through member 21, and another end is used as the hood to abut the opening of the casing 10. The support 22 is fastened connected to the casing 10 through the fastener 30. In some embodiments, the see-through member 21 can include a glass member or a member made of another transparent material. The see-through member 21 can be fixed at the support 22 by snapping or gluing. A sealing ring can also be provided between the see-through member 21 and the support 22. In an example embodiment, a size of the see-through member 21 depends on a movement range provided by the gimbal to the camera and a field of view of a lens of the camera, which is specifically based on a scene with a maximum angle that the camera can capture. The see-through member 21 may be flat or dome shaped.

In some embodiments, the see-through member 21 and the support 22 may also be an integral structure, as long as transparency and strength are ensured.

In some embodiments, the fastener 30 described in the above embodiments may include a locking ring. Two ends of the locking ring are connected to the casing 10 and the support 22, respectively. The casing 10 and the support 22 are adaptively matched with the shape of the locking ring. For example, the support 22 is configured as a cylindrical structure, and the shape of the casing 10 is configured as a trumpet shape. In some embodiments, the support 22 and the casing 10 may be configured as structures with different shapes. For example, the support 22 may also be configured as a prismatic structure, or a special-shaped structure, etc.

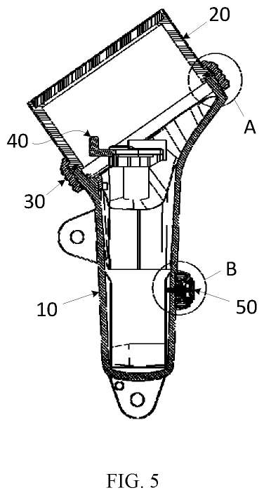

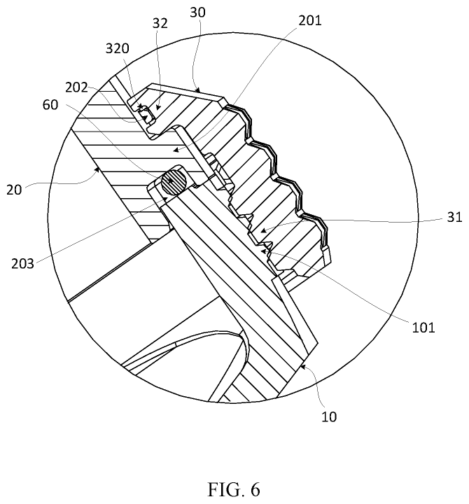

FIG. 5 is a cross-sectional view of the protective casing structure in FIG. 3. FIG. 6 is an enlarged schematic diagram of part A in FIG. 5. As shown in FIGS. 5 and 6, in an axial direction of the locking ring, one end of an inner wall of the locking ring is provided with an inner thread 31, and another end of the inner wall of the locking ring is provided with an inner boss 32. An outer wall of the casing 10 is provided with an outer thread 101. The outer wall of the support 22 is provided with an outer boss 201. After the casing 10 and the support 22 are locked by the locking ring, a threaded connection is formed between the inner thread 31 and the outer thread 101, and the inner boss 32 is clamped with the outer boss 201. In some embodiments, the outer thread 101 can also be provided at the outer wall of the support 22, and the outer boss 201 is provided at the outer wall of the casing 10. In an example embodiment, the inner thread 31 and the outer thread 101 include thread structures with self-locking function. Because of the self-locking thread, after the support 22 and the casing 10 are locked, a relative position between the support 22 and the casing 10 cannot be changed. A compression amount of the sealing member 60 provided between the support 22 and the casing 10 may be maintained at a stable value, thereby achieving a reliable sealing effect. In an example embodiment, the hood assembly 20 has both easy disassembly and waterproof reliability by using a waterproof means of the self-locking thread and the sealing ring. The deep-water imaging can also be achieved by using a material with a high compression resistance to make the hood assembly 20 and the casing 10.

Further, in an example embodiment, as shown in FIG. 6, on the outer wall of the support 22 provided with the outer boss 201, a first connecter 202 is further provided adjacent to the outer boss 201. The inner wall of the locking ring is also provided with a second connecter 320. The first connecter 202 cooperates with the second connecter 320 to realize the connection of the locking ring with the casing 10 or the support 22, and to provide guidance for a movement of the locking ring. In some embodiments, the first connecter 202 may include a convex ring arranged along a circumferential direction of the support 22, while the second connecter 320 includes a concave ring arranged along the circumferential direction of the locking ring, Alternately, the first connecter 202 may include the concave ring arranged along the circumferential direction of the support 22, while the second connecter 320 includes the convex ring arranged along the circumferential direction of the locking ring. The concave ring and the convex ring are engaged with each other. The movement of the locking ring includes a rotational movement relative to the support 22, a rotational movement relative to the casing 10, and a linear movement. When the locking ring performs a rotational movement, the convex ring cooperates with the concave ring to provide guidance. When the outer boss 201 is arranged at the casing 10, the first connecter 202 is located at the outer wall of the casing 10 correspondingly. In an example embodiment, the second connecter 320 is arranged at the inner boss 32.

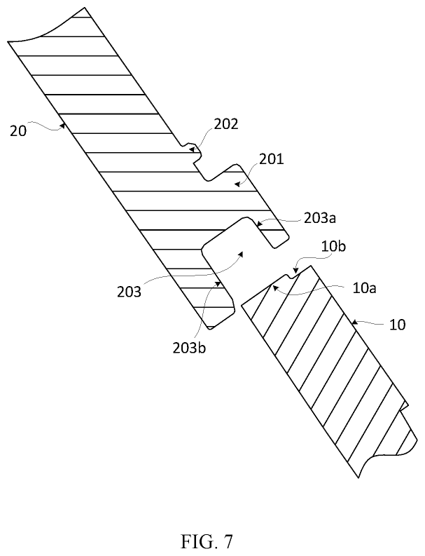

FIG. 7 is a sectional exploded view of the support 22 and the casing 10 in FIG. 6. As shown in FIG. 7, one end of the support 22 facing the casing 10 is provided with a groove 203 surrounding the hood. After the hood abuts against the opening, the casing 10 is partially inserted into the groove 203. Groove walls 203a, 203b of the groove 203 are attached to a portion where the casing 10 is inserted. This insertion method can improve a degree of sealing of the sealed cavity formed by the connection between the casing 10 and the hood assembly 20. Further, the portion where the casing 10 is inserted and a bottom of the groove 203 form an accommodation cavity. The sealing member 60 is arranged in the accommodation cavity no matter whether the hood assembly 20 is removed from the casing 10 or not, to prevent the sealing member 60 from being exposed to a greatest extent, to reduce a probability of the sealing member 60 being damaged, and to provide an accommodation space for the sealing member 60. The sealing member 60 can be stably accommodated in the accommodation cavity under an action of an elasticity of the sealing member 60, thereby preventing the sealing member 60 from frequently dropping during a process to assemble and disassemble the casing 10 and the support 22.

In some embodiments, one end of the casing 10 facing the support 22 may be provided with a step structure surrounding the opening. A convex 10a of the step structure is inserted into the groove 203, and the convex 10a is attached to the groove walls 203a, 203b of the groove 203. A concave 10b of the step structure forms an avoidance groove for a groove edge of the groove 203. Therefore, the degree of sealing of the sealed cavity can be improved. Further, another accommodation cavity is formed between the convex 10a of the step structure and the bottom of the groove 203. The sealing member 60 is arranged in the other accommodation cavity.

In some embodiments, the groove 203 may be provided at the one end of the casing 10 facing the support 22. Furthermore, the step structure may be arranged at the one end of the support 22 facing the casing 10.

In an example embodiment, as show in FIG. 4, an inner wall of the sealed cavity is symmetrically provided with a first mounting member 102 and a second mounting member (not shown). The loading assembly 40 correspondingly includes a first fixed loading member 41, a second fixed loading member 42, and a movable loading member 43 for loading the electronic device. The first fixed loading member 41 and the second fixed loading member 42 cooperate to clamp the movable loading member 43. The first fixed loading member 41, the second fixed loading member 42, and the movable loading member 43 are combined to form a mounting space for the electronic device. The first fixed loading member 41 is fixed to the first mounting member 102, while the second fixed loading member 42 is fixed to the second mounting member. In an example embodiment, a size of the mounting space can be adjusted by adjusting the relative positions between the movable loading member 43 and the first fixed loading member 41, and between the movable loading member 43 and the second fixed loading member 42, to adapt to the mounting of electronic devices with various shapes and sizes. In some embodiments, the first fixed loading member 41 and the second fixed loading member 42 are provided with a first sliding groove 411 (not shown) and a second sliding groove (not shown), respectively. The movable loading member 43 can be slid in or out of the first sliding groove 411 and the second sliding groove, to realize the loading and removing of the electronic device.

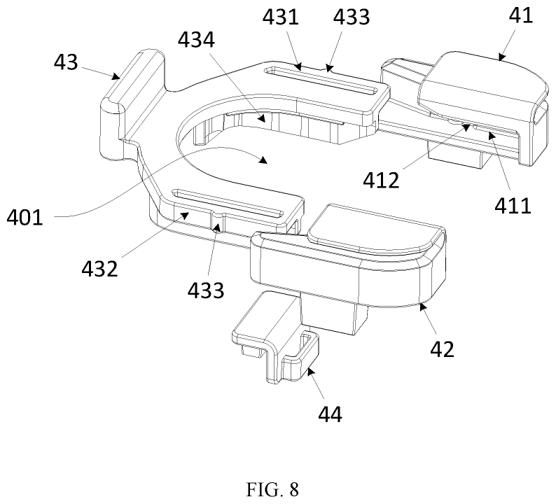

FIG. 8 is a schematic exploded structural diagram of the loading assembly 40 consistent with the embodiments of the disclosure. As shown in FIG. 8, the movable loading member 43 includes a first elastic edge 431 and a second elastic edge 432. At least one of the first elastic edge 431 or the second elastic edge 432 is provided with a convex point 433. When the movable loading member 43 is slid into the first sliding groove 411 and the second sliding groove, after the convex point 433 is pressed, the first elastic edge 431 and the second elastic edge 432 may be deformed. After the movable loading member 43 is slid into the first sliding groove 411 and the second sliding groove, the convex point 433 is engaged with concave points 412 provided in the first sliding groove 411 and the second sliding groove, to enable the first fixed loading member 41 and the second fixed loading member 42 to lock the movable loading member 43 jointly. In this scenario, the first elastic edge 431 and the second elastic edge 432 return to original states thereof.

In an example embodiment, as shown in FIG. 4, a third mounting member 103 is further provided at the wall of the sealed cavity. The loading assembly 40 further includes a third fixed loading member 44. The third fixed loading member 44 is mounted at the third mounting member 103, to assist the locking of the electronic device after the electronic device is loaded into the sealed cavity. In an example embodiment, the first fixed loading member 41, the second fixed loading member 42, and the third fixed loading member 44 are specifically arranged at different sides of the movable loading member 43.

In an example embodiment, a lower portion of the movable loading member 43 includes a soft rubber structure 434. When the movable loading member 43 clamps a gimbal arm of the gimbal, the shape of the soft rubber structure 434 fits the gimbal arm. Under the action of the movable loading member 43 and the casing 10, the gimbal and the camera as a whole can be stably loaded in the sealed cavity. Because the camera is movable in the casing 10, and the entire loading assembly 40 is outside of the movement range of the camera, which may not interfere with the movement of the gimbal and the camera. Therefore, the sealed cavity can reliably fix the gimbal and the camera in the casing 10 while meeting a requirement of the movement range of the camera. The entire loading assembly 40 has advantages of simple structure and reliable mounting.

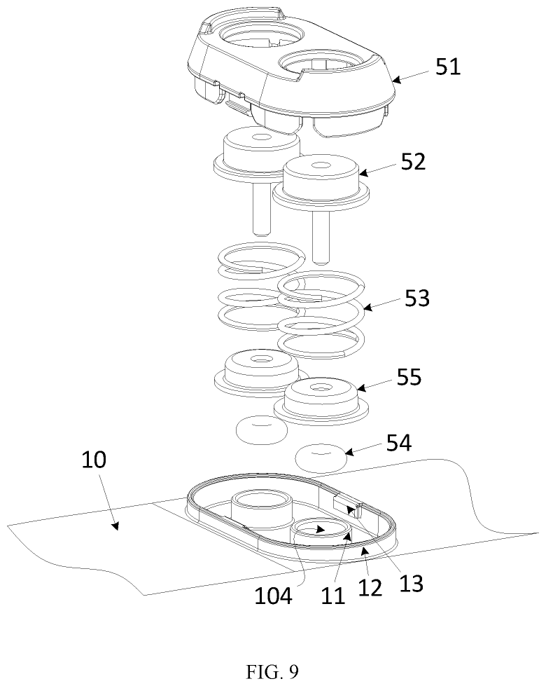

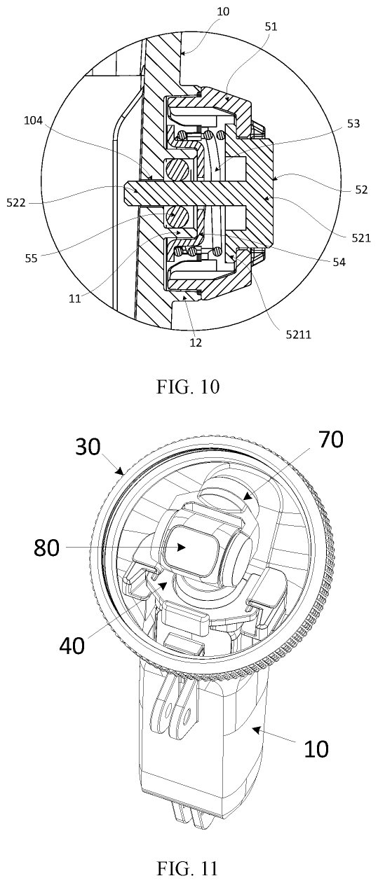

FIG. 9 is a schematic exploded structural diagram of the key assembly 50 consistent with the embodiments of the disclosure. FIG. 10 is an enlarged schematic diagram of part B in FIG. 5. As shown in FIGS. 9 and 10, the key assembly 50 includes a package 51, a pressing member 52, a resetting member 53, and a sealing assembly. The key mounting member includes a through hole 104 passing through the casing 10. The pressing member 52 sequentially passes through the resetting member 53, the sealing assembly, and the through hole 104. When the pressing member 52 is pressed externally, the pressing member 52 may squeeze and press the resetting member 53 to cause the resetting member 53 to be moved in the casing 10 and finally to squeeze a key of the gimbal and trigger the key. One end of the resetting member 53 abuts against the pressing member 52, and another end of the resetting member 53 may abut against the sealing assembly or the casing 10. The entire package 51 is arranged outside of the pressing member 52, the resetting member 53, and the sealing assembly, and is connected to the casing 10 in a sealed manner. In some embodiments, the package 51 can be connected to the casing 10 by a mean, such as gluing or snapping.

As shown in FIG. 9, the key mounting member further includes a first convex ring 11 arranged surrounding the through hole 104. The pressing member 52 includes an end cap 521 and a pressing shaft 522 connected to each other. The sealing assembly includes a sealing ring 54 and a sealing cover 55.

The one end of the resetting member 53 abuts against the end cap 521, and the other end may abut against the sealing cover 55 or the casing 10.

The sealing ring 54 is located in the first convex ring 11, and the sealing cover 55 is arranged on the first convex ring 11. That is, the sealing ring 54 is arranged in a space formed by a cooperation of the first convex ring 11 and the sealing cover 55. The pressing shaft 522 sequentially passes through the resetting member 53, the sealing cover 55, the sealing ring 54, and the through hole 104.

In some embodiments, the end cap 521 is provided through the through hole of the package 51. The edge of the end cap 521 is provided with a limiting flange 5211 that abuts against the package 51. The limiting flange 5211 and the sealing cover 55 or the casing 10 jointly limit a movement range of the pressing shaft 522 to prevent the pressing shaft 522 from damaging the keys of the gimbal or another electronic device due to excessive stroke.

In some embodiments, a part of the package 51 away from the casing 10 is made of a soft material. The end cap 521 abuts against the soft material part of the package 51. The soft material part of the package 51 and the sealing cover 55 or the casing 10 jointly limit the movement range of the pressing shaft 522 to prevent the pressing shaft 522 from damaging the keys of the gimbal or another electronic device due to excessive stroke.

In some embodiments, the key mounting member further includes a second convex ring 12 arranged around the first convex ring 11. The sealing cover 55 is located between the first convex ring 11 and the second convex ring 12. The package 51 is mutually connected with a snap 13 provided at the inner wall of the second convex ring 12. In some embodiments, another sealing ring may also be provided between the package 51 and the second convex ring 12.

In some embodiments, the key assembly 50 includes at least two sets of the pressing member 52, the resetting member 53, and the sealing assembly. The key mounting member includes a corresponding number of the through holes 104. In some embodiments, the at least two sets of the pressing member 52, the resetting member 53, and the sealing assembly can be packaged by one package 51, or each set corresponds to one package 51.

In an example embodiment, the resetting member 53 includes a resetting spring. The stiffness of the resetting spring is configured to be able to resist a water pressure for working in a deep-water environment, thereby preventing the pressing member 52 from mistakenly touching the key due to water pressure. In some embodiments, the resetting member 53 may also include another component or structure with a resetting function, which is not limited here.

The key assembly 50 only needs to be fixed by the casing 10. No matter how complicated the external shape of the casing 10 and how the inner cavity structure is twisted, the key assembly 50 can be applied, and the key assembly 50 has a simple structure and a relatively large waterproof depth.

As shown in FIG. 3, the casing 10 is also provided with at least one connector 105 connected to an external structure, which can be used to connect a rope or another fixed structure.

In the above embodiments of the present disclosure, the materials of the various parts of the protective casing structure can include various metals or plastics. The waterproof depth of the protective casing structure can be increased or decreased accordingly by appropriately increasing or decreasing a wall thickness of the various parts of the protective casing structure.

The sealing member 60 or the sealing ring 54 can be made of rubber or another elastic material with a waterproof function.

Compared with the existing technology, the protective casing structure consistent with the embodiments of the present disclosure at least includes following beneficial effects.

First, the gimbal and camera can be mounted stably to enable the camera to cooperate with the gimbal to adapt to an underwater scene, and to enable the camera to move inside the casing 10 and achieve a wider imaging angle of view underwater.

Second, the self-locking thread is matched with the sealing ring 54 to achieve the sealing with good waterproof performance. The hood assembly 20 is easier to be disassembled and assembled to be more convenient for opening, thereby achieving a better protective effect of the sealing member 60 between the hood assembly 20 and the casing 10 and increasing a service life.

Third, the key assembly 50 has a good waterproofness, a simple structure, and a wider applicability, which is suitable for the casing 10 of various shapes. The gimbal can be operated underwater through the key assembly 50.

The handheld gimbal consistent with the embodiments of the present disclosure can be used for loading an electronic device. In an example embodiment, the electronic device is a camera. FIG. 11 is a schematic diagram showing the protective casing structure without the hood assembly 20 being applied with the handheld gimbal and a camera 80. As shown in FIG. 11, the handheld gimbal includes a gimbal 70 and the above-described protective casing structure. The camera 80 is loaded on the gimbal 70. The gimbal 70 is fixed to the mounting member in the sealed cavity. In some embodiments, the gimbal may be a single-axis gimbal or a multi-axis gimbal.

The gimbal 70 is fixed to the mounting member in the sealed cavity by a loading assembly 40. With reference to FIG. 4, the loading assembly 40 includes the movable loading member 43 and at least one fixed loading member connecting the movable loading member 43 to the mounting member. The movable loading member 43 is provided with an open groove 401 for clamping the gimbal 70. The fixed loading member is specifically referred to the first fixed loading member 41 and the second fixed loading member 42 shown in FIG. 3 and FIG. 4. In some embodiments, the gimbal 70 may include a gimbal arm or a handheld arm. The open groove 401 clamps the gimbal arm or the handheld arm. Further, the sealed cavity of the protective casing structure may be adapted to the shape of the gimbal 70. For example, if the gimbal 70 includes a handheld arm, the sealed cavity may be correspondingly configured with another accommodation space for the handheld arm.

In the embodiments of the present disclosure, the loading assembly 40 further includes at least another one fixed loading member for locking the gimbal arm, which is specifically referred to the third fixed loading member 44 shown in FIG. 4. The third fixed loading member 44 may be fixed connected with the structure on the gimbal. The first fixed loading member 41, the second fixed loading member 42, and the third fixed loading member 44 can fix the gimbal 70 from different directions.

The handheld gimbal consistent with the embodiments of the present disclosure can be used with an electronic device, such as a camera, to enable the electronic device to be used stably in the sealed cavity of the protective casing structure. The handheld gimbal adopts the above-described protective casing structure thus has the beneficial effects of the protective casing structure described above, which are omitted here.

As shown in FIG. 11, the imaging device consistent with the embodiments of the present disclosure includes the camera 80 and the above-described handheld gimbal. The camera 80 is mounted on the gimbal 70. In the embodiments of the present disclosure, the hood assembly 20 of the protective casing structure includes a see-through unit facing a lens of the camera 80 to form an imaging window of the lens. The see-through unit may be flat or dome shaped. There is an activity space between the see-through unit and the lens for the lens to move.

The camera of the imaging device consistent with the embodiments of the present disclosure can be adapted to imaging of special scenes under the protection of the protective casing structure and can be cooperated with the gimbal to realize stable imaging. The imaging field of view of the camera is larger. The imaging device consistent with the embodiments of the present disclosure adopts the protective casing structure and the handheld gimbal described in the above embodiments thus has the beneficial effects of the protective casing structure and the handheld gimbal described above, which are omitted here.

Other embodiments of the disclosure will be apparent to those skilled in the art from consideration of the specification and practice of the embodiments disclosed herein. It is intended that the specification and examples be considered as example only and not to limit the scope of the disclosure, with a true scope and spirit of the invention being indicated by the following claims.

What is claimed is:

1. A protective casing structure comprising:
a hood assembly including a hood;
a casing configured to be locked to the hood assembly to form a sealed cavity, one end of the casing being provided with an opening adapted to a shape of and abutting against the hood; and
a mounting member arranged in the sealed cavity and configured to mount an electronic device;
wherein the sealed cavity provides a space for the electronic device to move in the space.

2. The protective casing structure of claim 1, further comprising:
a sealing member provided at an abutment between the casing and the hood assembly;
wherein the casing and the hood assembly are configured to compress the sealing member after the casing and the hood assembly are locked to each other.

3. The protective casing structure of claim 1, wherein the hood assembly further includes:
a see-through member including a see-through unit facing the electronic device loaded in the sealed cavity; and
a support configured to be fastened to the casing and including an inner cavity penetrating the support, a first end of the inner cavity being fixed to the see-through member, and a second end of the inner cavity forming the hood.

4. The protective casing structure of claim 3, wherein the support is configured as a cylindrical structure.

5. The protective casing structure of claim 3, wherein the second end of the support is provided with a groove surrounding the hood configured to, when the hood abuts against the opening, receive a portion of the casing with a groove wall of the groove attaching the portion of the casing.

6. The protective casing structure of claim 5, wherein one end of the casing towards the support is provided with a step structure surrounding the opening, a convex of the step structure configured to be inserted into the groove, and a concave of the step structure forms an avoidance groove for a groove edge of the groove.

7. The protective casing structure of claim 5, wherein an accommodation cavity is formed between the portion of the casing inserted in the groove and a bottom of the groove, and a sealing member is provided in the accommodation cavity.

8. The protective casing structure of claim 1, further comprising:
a fastener configured to lock the casing to the hood assembly.

9. The protective casing structure of claim 8, wherein the fastener includes a locking ring, and two ends of the locking ring are connected to the casing and the hood assembly, respectively.

10. The protective casing structure of claim 9, wherein:
in an axial direction of the locking ring, one end of an inner wall of the locking ring is provided with an inner thread, and another end of the inner wall of the locking ring is provided with an inner boss;
an outer wall of one of the casing and the hood assembly is provided with an outer thread, and an outer wall of another one of the casing and the hood assembly is provided with an outer boss; and
after the casing and the hood assembly are locked by the locking ring, a threaded connection is formed between the inner thread and the outer thread, and the inner boss and the outer boss are clamped with each other.

11. The protective casing structure of claim 10, wherein:
a first connecter is provided adjacent to the outer boss at the outer wall of the another one of the casing and the hood assembly provided with the outer boss, and a second connecter is provided at the inner wall of the locking ring; and
the first connecter is configured to cooperate with the second connecter to realize a connection of the locking ring with the casing or the hood assembly, and to provide guidance for a movement of the locking ring.

12. The protective casing structure of claim 11, wherein the second connecter is arranged at the inner boss.

13. The protective casing structure of claim 1, wherein one of the support and the casing is provided with a fastening member, and another one of the support and the casing is provided with a fastening fitting member configured to be connected with the fastening member.

14. The protective casing structure of claim 1, wherein the casing is further provided with a key mounting member, and a key assembly is mounted at the key mounting member.

15. The protective casing structure of claim 14, wherein:
the key assembly includes a package, a pressing member, a resetting member, and a sealing assembly;
the key mounting member includes a through hole passing through the casing;
the pressing member is arranged passing through the resetting member, the sealing assembly, and the through hole in sequence;
one end of the resetting member is configured to abut against the pressing member, and another end of the resetting member is configured to abut against the sealing assembly or the casing; and
the package covers the pressing member, the reset member, and the sealing assembly, and is connected to the casing in a sealed manner.

16. A handheld gimbal comprising:
a protective casing structure including:
a hood assembly including a hood;
a casing configured to be locked to the hood assembly to form a sealed cavity, one end of the casing being provided with an opening adapted to a shape of and abutting against the hood; and
a mounting member arranged in the sealed cavity; and
a gimbal fixed at the mounting member and configured to mount an electronic device;
wherein the sealed cavity provides a space for the electronic device to move in the space.

17. The handheld gimbal of claim 16, wherein:
the gimbal is fixed at the mounting member through a loading assembly;
the loading assembly includes a movable loading member and at least one fixed loading member connecting the movable loading member to the mounting member; and
the movable loading member is provided with an open groove configured to clamp a gimbal arm of the gimbal.

18. The handheld gimbal of claim 17, wherein:
the at least one fixed loading member is at least one first fixed loading member; and
the loading assembly further includes at least one second fixed loading member configured to lock the gimbal arm.

19. An imaging device comprising:
a handheld gimbal including:
a protective casing structure including:
a hood assembly including a hood;
a casing configured to be locked to the hood assembly to form a sealed cavity, one end of the casing being provided with an opening adapted to a shape of and abutting against the hood; and
a mounting member arranged in the sealed cavity; and
a gimbal fixed at the mounting member; and
a camera mounted at the gimbal;
wherein the sealed cavity provides a space for the camera to move in the space.

20. The imaging device of claim 19, wherein the hood assembly includes a see-through member facing a lens of the camera to form an imaging window for the lens.
